(19) United States
(12) Patent Application Publication
(10) Pub. No.: US 2026/0003533 A1
(43) Pub. Date: Jan. 1, 2026

(54) DEVICE STORAGE OPTIMIZATION

(71) Applicants: Beijing Zitiao Network Technology Co., Ltd., Beijing (CN); LEMON INC., Grand Cayman (KY)

(72) Inventors: Wei HE, Beijing (CN); Chong CHONG, Beijing (CN); Shenglan HUANG, Culver, CA (US); Xiaolei LI, Beijing (CN); Haiqing TAO, Beijing (CN); Mingkui LIU, Culver, CA (US); Qian MA, Beijing (CN)

(21) Appl. No.: 19/253,553

(22) Filed: Jun. 27, 2025

Related U.S. Application Data
(63) Continuation of application No. PCT/CN2024/102519, filed on Jun. 28, 2024.

(51) Int. Cl. G06F 3/06

(52) U.S. Cl. CPC G06F 3/0652; G06F 3/0608; G06F 3/0616; G06F 3/0673

(57) ABSTRACT

Methods, systems, and apparatus, including computer programs encoded on computer storage media, for optimizing storage on a user device where an application for streaming video content is executed. Lifespans of videos stored on a disk of a device or in a memory of the device can be determined based on computed repeat probability rates for the videos. Weighted ratios for each of the videos can be computed as a ratio between a lifespan of the respective video and a duration of time for storage of the video on a) the disk or b) in memory. One or more video can be determined to be removed from the videos based on applying a deletion ratio over a sorted list of the videos. The sorted list is generated based on the computed weighted ratios.

### CROSS-REFERENCE TO RELATED APPLICATION(S)

This application claims priority to PCT Application No. PCT/CN2024/102519 filed Jun. 28, 2024, the disclosure of which is incorporated herein by reference in its entity.

### BACKGROUND

This specification relates to video storage.

Video content can be provided by a content delivery system or server for viewing on a user device. Video content can be selected for streaming to an individual user device. When video content is requested for streaming through an application installed on the individual user device, the content delivery system receives a request such as a download operation and provides the content to be stored on the device and to be displayed at a user interface of the application. Such read and write operations of the user device can have high latency, for example, when requested from a device with limited computational or hardware resources that also have high disk utilization.

### SUMMARY

This specification describes technologies for optimizing the storage of videos on user devices.

In general, one innovative aspect of the subject matter described in this specification can be embodied in methods that include the actions of determining lifespans of videos stored on a disk of a device or in a memory of the device, wherein the lifespan is determined based on computed repeat probability rates for the videos; computing weighted ratios for each of the videos, wherein a weighted ratio for a video is computed as a ratio between a lifespan of the respective video and a duration of time for storage of the video on a) the disk or b) in memory; and determining to remove one or more video from the videos based on applying a deletion ratio over a sorted list of the videos, wherein the sorted list is generated based on the computed weighted ratios, and wherein the deletion ratio is defined for the device based on a user device profile.

Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed it on software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this specification can be implemented in particular embodiments so as to realize one or more of the following advantages. The techniques of the present disclosure support improved disk utilization that improves the performance of the device, and in particular, the performance of an application providing video rendering. The input/output operations performed by a device to request input from external storages can be reduced by optimizing the storage to maintain data (e.g., videos) that are with higher likelihood of replaying. For example, the content storage at the device can be automatically evaluated and adjusted to match user behavior and interaction style. Based on implemented techniques of the present disclosure, latency of user devices when providing video streaming can be reduced. In some implementations, the main memory utilization can be adjusted to support an improved device performance when executing programs and/or streaming video.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example video processing pipeline.

FIG. 2A is a flow diagram of an example process for optimizing storage on devices.

FIG. 2B is a flow diagram of an example process for determining videos to be deleted from a memory or a disk of a user device.

FIG. 2C is a flow diagram of an example process for determining whether to store videos on the disk of a device.

FIG. 2D is a flow diagram of an example process for determining whether to store videos on the disk of a device.

FIG. 3 is a block diagram of an example device storage optimizing service.

FIG. 4 is a block diagram of an example computing system.

Like reference numbers and designations in the various drawings indicate like elements.

### DETAILED DESCRIPTION

The present specification describes techniques for implementing a process for optimizing storage on a user device where an application for streaming video content is executed. The storage optimization is based on considerations for improved disk utilization that can affect the performance of the device and the video rendering. In accordance with implementations of the present disclosure, a storage optimization solution can be provided that reduces input/output operations' latency for the device. The device can be a mobile phone, a tablet, a laptop, etc. In some cases, when the user device does not frequently replay videos through an application on the user device, such videos may not be stored in the memory or on the disk (e.g., deleted if previously stored) to minimize the storage of content that is not frequently requested and may be associated with lower likelihood being requested for viewing again. For example, when a video is requested for display at a device, the video can be stored at the hard disk of the device and/or at the main memory (Random-Access Memory (RAM)) of the device. The main memory can be a temporary memory storage where the device can store data that is easily retrievable. The main memory is also used for programs or parts of programs that are currently executed at the device and data required for their execution. As such, the storage of video content on the user device (at the hard disk, or at the main memory) can be analyzed to determine which video files to maintain or store in the memory or on the disk so that the performance of the user device is maintained above a certain threshold level.

Latency of read or write operations at a user device (e.g., read requests for video content from a content provider) can be a result of high disk/memory utilization of the user device. When the disk/memory utilization of a device is high (e.g., above a threshold percentage), the hard disk may be no longer capable to (or with a time delay) execute further commands or process data. This can result in slowing down of the device performance or in downtime for the device. The increased disk utilization for a device can have an even more severe impact on devices that are not so powerful and not configured with large disk volume and computer processing units (CPUs).

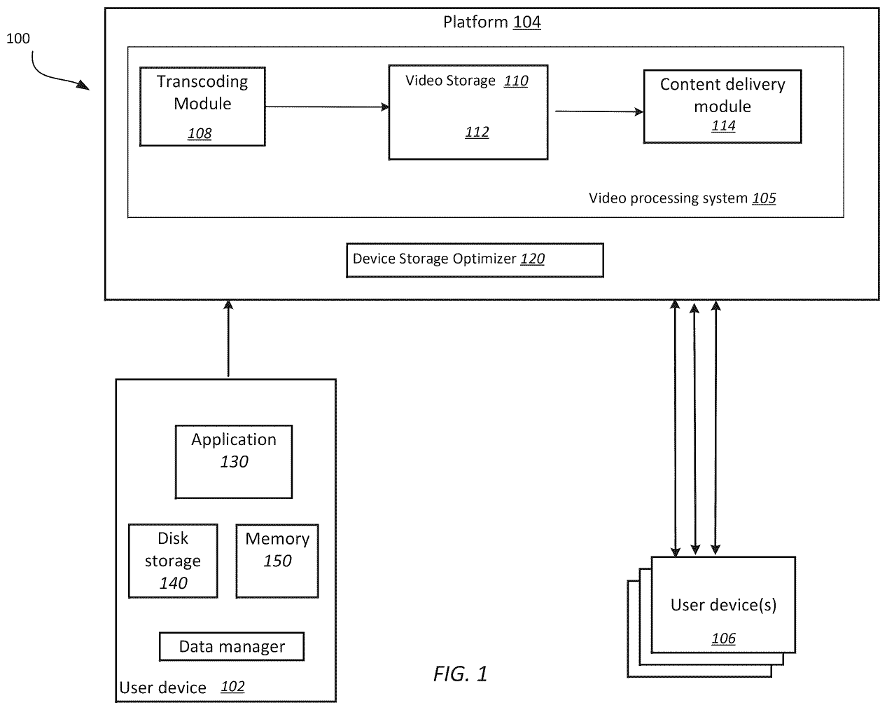

FIG. 1 shows a block diagram of an example video processing pipeline 100. The video processing pipeline 100 illustrates an example video processing by a platform 104, e.g., a social media platform, for delivery.

A user device 102 can provide a video to the platform 104. Videos can be received by user devices 106. The user devices 102 and 106 can be any Internet-connected computing device, e.g., a laptop or desktop computer, a smartphone, or an electronic tablet. The user devices can be connected to the Internet through a mobile network, through an Internet service provider (ISP), or otherwise. The user devices can have a hard disk and a memory. The hard disk and the memory are types of computer memory. The memory can be used for storing computer programs or software on the user device and also data that is used by the processor of the user device in real time. The memory is volatile and can be erased when the device is turned off. The hard disk is a permanent storage and can be used for storing different types of data including video content provided by the platform 104 and stored thereon. The hard disk can also store operating system files and other metadata.

Each user device can be configured with software, which will be referred to as a client or as client software. For example, the user device 102 is configured with application 130 that is client software that in operation can access the platform 104 so that a user can interact with the platform 104. The user devices 106 can also be configured with client software such as the application 130 to access and interact with the platform 104.

The client software (e.g., application 130) can include a user interface supporting user interactions with the platform 104 including sending requests and receiving content. For example, the user can use the client software to upload video content to the platform 104 as well as receive videos from the platform 104. The client software can be a platform specific application installed on the user device, or can be a web-based application running in a browser.

In some implementations, the user interface of the client software can include a view for presenting a feed of videos, obtained from the platform 104 that the user can interact with. For example, the user can scroll up or down to switch between videos in the feed as well as interact with individual videos, e.g., by posting comments about the video, sharing the video, or expressing approval, e.g., liking the video.

In some implementations, the video content provided by the platform to user devices can be video files of various lengths. For example, some videos may be short videos below a length threshold (e.g., below 60 seconds) or long videos (e.g., above 60 seconds). In other examples, short form videos are videos that are less than 90 seconds in length, and long form videos are videos that are above 90 seconds in length. In some implementations, short form videos have lengths of between 15 and 60 seconds. In some cases, long-form videos typically have lengths of at least 3 minutes. Short form videos can be defined according to specification and constraints defined for the platform 104 and have a length that is configured for the platform 104.

In the example video processing pipeline 100, the user device 102 obtains or creates a video. For example, the user device 102 can be a mobile device that generates the video using a camera of the mobile device. The user of the user device 102 can use the application 130 to upload the video to the platform 104, for example, to make the video content available for distribution to other users of the platform 104.

The platform 104 processes videos received from the user device 102 or otherwise obtained. The video processing can include various operations in addition to those described in this specification. For example, the video can be encoded with a particular encoding depending on the format of the received video. The content of the video can be analyzed, for example, to categorize the video or flag the video content as prohibited. For clarity, FIG. 1 is focused on a video processing system 105 of the platform 100 that transcodes and stores video content for delivery to user devices 106.

The video can be transcoded by a transcoding module 108. Video transcoding is a digital to digital conversion of one video encoding to another. In video streaming, transcoding allows for videos having different characteristics to be provided to user devices. For example, in low bandwidth network conditions, a lower resolution or lower bitrate version of the video can be provided to reduce potential stalling or buffering of the video while at higher bandwidth network conditions, higher resolution or bitrate versions can be provided. To provide these different versions of the video, the received video is transcoded by the transcoding module 108 into a number of different versions. The collected set of versions of the video are referred to as video ladders.

Once the video has been transcoded into multiple versions, the versions are stored as video ladders 112 in video storage 110. The video storage 110 may be a distributed storage among multiple storage devices. Further, the video storage 100 may be replicated in multiple locations such that multiple copies of the versions are stored, e.g., in multiple datacenters.

For new videos uploaded to the platform 104, the video storage 110 may make the ladder versions readily available for serving to user devices. A content delivery module 114, in response to an interaction with different end user devices 106, selects videos to provide to each user device 106 as well as the appropriate version from the corresponding video ladder 112. The selected version is then provided to the user device 106 for playback.

In some implementations, video processing system 105 may include other video processing, for example, compression of video data or re-encoding of input videos into a particular format.

In some implementations, a device storage optimizer 120 can be provided at the platform 104 to obtain data for video files from the video storage 115, the user devices and use profiles of the devices, and other interaction data for video streamed and/or downloaded at respective user devices to determine an optimized storage strategy for the user devices so that the disk/memory storage is optimized. Such storage optimization can minimize the disk or memory input/output operations' latency.

In some implementations, the device storage optimizer 120 can be implemented as a separate system or service outside of the platform 104. In some implementations, the device storage optimizer 120 can be executed on the user devices, for example, as part of the logic implemented for the application 130.

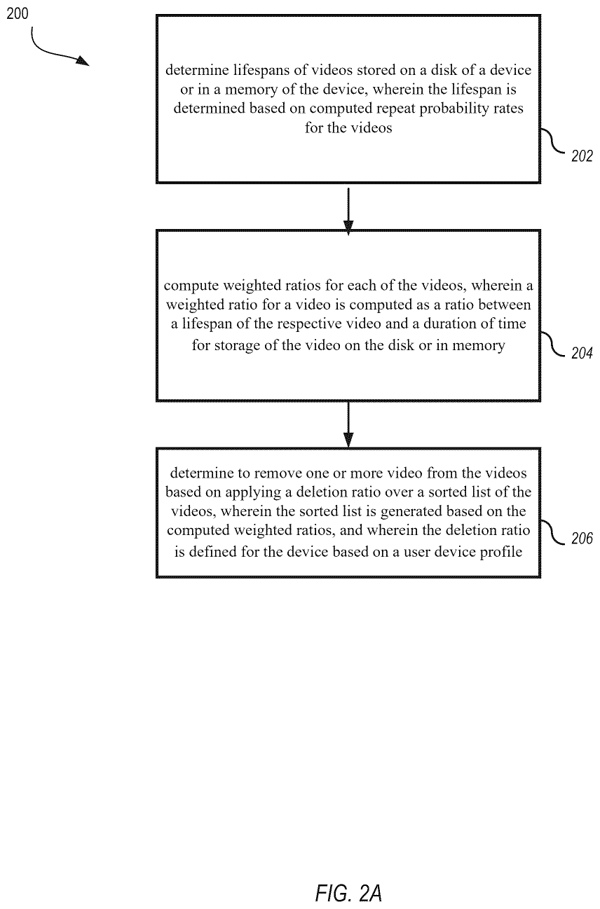

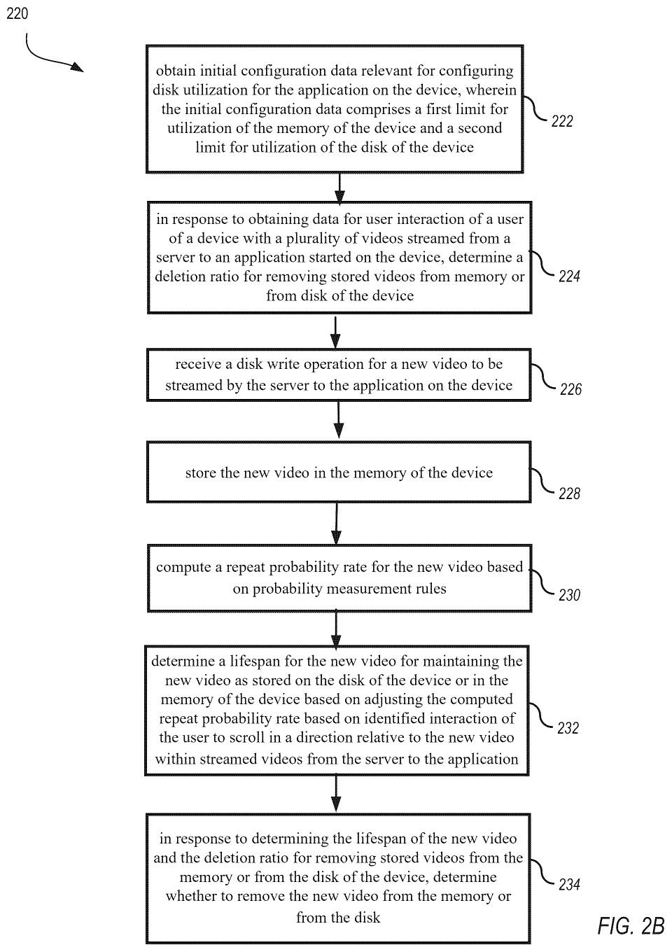

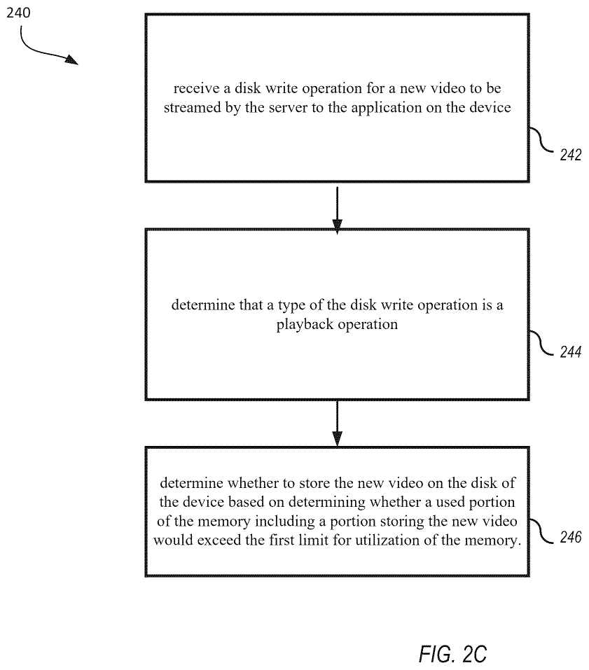

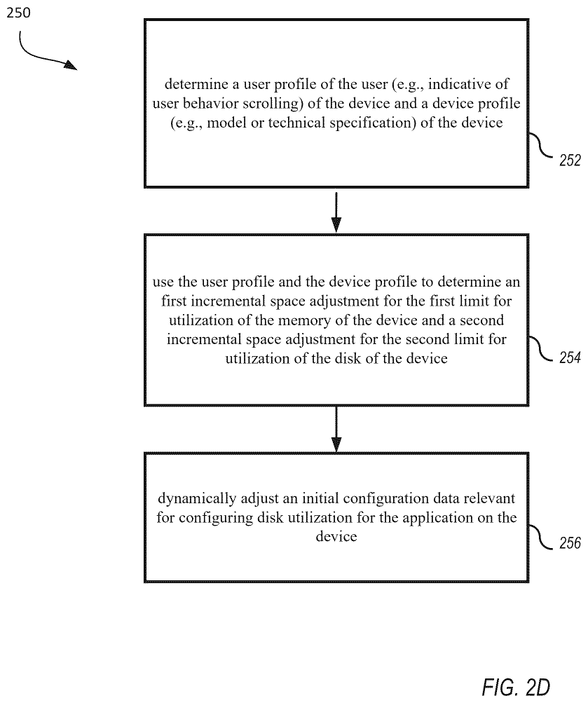

FIG. 2A is a flow diagram of an example process for optimizing storage on devices. For convenience, the process 200 will be described as being performed by a system of one or more computers, located in one or more locations, and programmed appropriately in accordance with this specification. For example, a system or service, e.g., the device storage optimizer 120 of FIG. 1, appropriately programmed, can perform the process 200. In some instances, the process 220 can be implemented to optimize the storage utilization of a user device such as the user device 102 of FIG. 1. For example, the process can be implemented to optimize storage for a device that accesses and performs read and write operations (input/output operations) from a content platform, e.g., the platform 104 of FIG. 1.

The system determines lifespans of videos stored on a disk of a device or in a memory of the device (202). The lifespan is determined based on computed repeat probability rates for the videos.

In some instances, the repeat probability rate is indicative of a likelihood that a video will be requested to be viewed again by a user at the user device. The determination of the likelihood can be made based on considerations of the user interaction and the distance between a currently viewed video and the particular video for which the repeat probability rate is determined. In some instances, the repeat probability rate can be also called repeat probability to refer to the likelihood of repeating the video by the user.

The system computes weighted ratios for each of the videos (204). A weighted ratio for a video is computed as a ratio between a lifespan of the respective video and a duration of time for storage of the video on the disk or in memory. Each video file stored on the disk or memory of the device can be associated with a respective weighted ratio.

The system determines to remove one or more videos from the videos based on applying a deletion ratio over a sorted list of the videos (206). The sorted list is generated based on the computed weighted ratios, and wherein the deletion ratio is defined for the device based on a user device profile.

In some instances, the system can instruct deletion of the determined one or more videos to be removed from the memory or from the disk of the device. In some cases when the optimization logic is performed at the device, for example, the device storage optimizer 120 is stored and running at the user device, the deletion is initiated to be executed, for example, at a particular time point or time period (or directly executed upon determining).

FIG. 2B is a flow diagram of an example process for determining videos to be deleted from a memory or a disk of a user device. For convenience, the process 220 will be described as being performed by a system of one or more computers, located in one or more locations, and programmed appropriately in accordance with this specification. For example, a system or service, e.g., the device storage optimizer 120 of FIG. 1, appropriately programmed, can perform the process 220. In some instances, the process 220 can be implemented to optimize the storage utilization of a user device such as the user device 102 of FIG. 1. For example, the process can be implemented to optimize storage for a device that accesses and performs read and write operations (input/output operations) from a content platform, e.g., the platform 104 of FIG. 1.

The system obtains, at an application started on the user device, initial configuration data relevant for configuring storage utilization for the application on the device (222). In some instances, that configuration can be defined by default for given devices or users. For example, the optimization service can determine the type or profile of a device (e.g., based on processing information at the header of messages exchanged between the service and the device) and assign initial configuration that maps to the determined type or profile. The initial configuration data comprises a first limit for utilization of a memory of the device or a second limit for utilization of a disk of the device.

The system obtains data for user interaction(s) of a user of the device with a plurality of videos streamed from a server to an application started on the device. Based on the obtained data, the system determines a deletion ratio for removing stored videos from memory or from disk of the device (224).

The system receives a disk write operation for a new video to be streamed by the server to the application on the device (226).

The system stores the new video in the memory of the device in response to receiving the disk write operation for the new video (228)

The system computes a repeat probability rate for the new video based on probability measurement rules (230).

The system determines a lifespan for the new video for maintaining the new video as stored on the disk of the device or in the memory of the device (232). The determination of the lifespan is made by adjusting the computed repeat probability rate based on identified interaction of the user to scroll in a direction relative to the new video within streamed videos from the server to the application.

In response to determining the lifespan of the new video and the deletion ratio for removing stored videos from the memory or from the disk of the device, the system determines whether to remove the new video from the memory or from the disk (234). When a video is determined to be deleted, the system can send instructions to the device to perform the deletion from the memory.

In some cases, when one or more videos from a list of videos stored in the memory are to be deleted, the one or more videos can be determined to be written to the disk of the device, for example, if such storage would not violate utilization limits for the disk of the device.

FIG. 2C is a flow diagram of an example process for determining whether to store videos on the disk of a device. For convenience, the process 240 will be described as being performed by a system of one or more computers, located in one or more locations, and programmed appropriately in accordance with this specification. For example, a system or service, e.g., the device storage optimizer 120 of FIG. 1, appropriately programmed, can perform the process 240. In some instances, the process 240 can be implemented to optimize the storage utilization of a user device such as the user device 102 of FIG. 1. For example, the process can be implemented to optimize storage for a device that accesses and performs read and write operations (input/output operations) from a content platform, e.g., the platform 104 of FIG. 1.

The system receives data for a requested disk write operation (242). The system can receive the information through subscribing for events performed at the user device or, for example, based on being executed as a service within the application that is used to request video content that is to be written on the user device, e.g., in the memory or on the disk.

The system determines that the type of the disk write operation is a playback operation (244).

The system determines whether to store the new video on the disk of the device (246). Such determination is made based on determining whether a used portion of the memory including a portion for storing the new video would exceed the first limit for utilization of the memory. In such a way, the system can determine if the storage in the memory would exceed a defined limit, i.e., the first limit if the video is stored.

FIG. 2D is a flow diagram of an example process for determining whether to store videos on the disk of a device. For convenience, the process 240 will be described as being performed by a system of one or more computers, located in one or more locations, and programmed appropriately in accordance with this specification. For example, a system or service, e.g., the device storage optimizer 120 of FIG. 1, appropriately programmed, can perform the process 250. In some instances, the process 250 can be implemented to optimize the storage utilization of a user device such as the user device 102 of FIG. 1. For example, the process can be implemented to optimize storage for a device that accesses and performs read and write operations (input/output operations) from a content platform, e.g., the platform 104 of FIG. 1.

In some instances, to manage the storage utilization at a device, the system defines an initial configuration to set deletion limitations for the disk or memory of the device so as to maintain the storage below a certain threshold. The threshold can be determined in consideration with the device and/or the user. In some cases, devices can have a lot of space on their hard disk and a lot of memory, thus allocation of more memory to be used for storing video content may be defined compared to cases where the device is with limited disk and memory resources.

In some instances, a determination of how to initialize the configuration for an application on a device can be performed based on determining a user profile of a user associated with the application and the type of the device, e.g., the device profile. For example, the user profile can categorize the user based on information for the style of interaction of the user with video content, for example, how fast does he scroll through videos. In some examples, information for the device technical specification (e.g., determined based on information for the model of the device or serial number of the device) can be obtained and used to map to a device profile. Based on determining such user profile and/or device profile, a determination can be made for the initial configuration that is done for the device to include limits for memory utilization of the memory and the disk that map to the user profile and/or the device profile. Once the initial configuration is set, the configuration can be dynamically adjusted to reflect on the user behavior interacting with video content as streamed from the platform.

In some instances, the initial configuration data includes a first limit for utilization of a memory of the device or a second limit for utilization of a disk of the device.

The system determines the user profile of the user of the device and a device profile of the device (252). The user profile data is indicative for the identified user behavior. The system uses the user profile and the device profile to determine a first incremental space adjustment for the first limit for utilization of the memory of the device and a second incremental space adjustment for the second limit for utilization of the disk of the device (254). The system dynamically adjusts the initial configuration data by applying the first incremental space adjustment and the second incremental space adjustments to the limits for utilization of the memory and the disk of the device. The first incremental space adjustment is applied to the first limit for utilization of the memory of the device as defined in the initial configuration. The second incremental space adjustment is applied to the second limit for the utilization of the disk of the device as defined in the initial configuration.

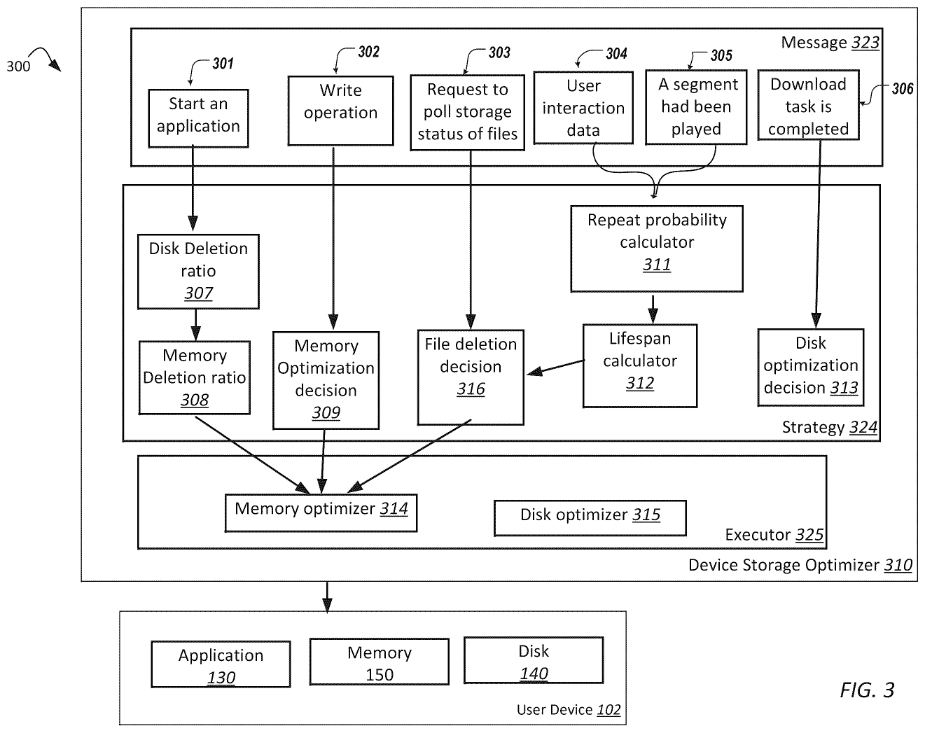

FIG. 3 is a block diagram of an example device storage optimizing service 310. The device storage optimizer 310 can be implemented to process data for a set of video files that can be provided from a content delivery system to a user device for downloading and/or viewing. For example, the storage optimizer 310 can be substantially the same as the device storage optimizer 120 at the platform 104 of FIG. 1. The device storage strategy service 300 can be executed to process data related to video content at the content delivery system, to user interaction with at least one of the video files, and to a device profile.

The device storage optimizer 310 can be implemented according to an architecture that includes a message 323 layer, a strategy 324 layer, and an executor 325 layer. These layers can be configured to obtain data for a device, such as the user device 102 of FIG. 1, in relation to performed operations at the user device, to existing storage of video files in the memory and/or on the disk, and/or the device itself (e.g., device profile or specification). Such data can be received as messages 323 and used as triggering input for performing operations (e.g., storage decisions for deletion of video files) at the strategy 324 layer. The performed operations at the strategy 324 layer can generate one or more outputs that can be used as input for generating instructions at the executor 325 layer. In some instances, a memory optimizer 314 and a disk optimizer 315 can obtain input from the data processing performed at the strategy 324 layer to provide instructions to the user device 102 to store and/or delete video files on the disk 140 or in the memory 150 of the user device 102. The message 323 layer includes data, for example, in the form of messages obtained from the device 102. The obtained messages can include notifications and/or events. For example, the message 323 layer includes a start of an application (301) event, a notification for a write operation (302), a request to poll storage status of files (303), input with user interaction data (304), a notification that a segment of a video have been played (305), a notification that a download task is completed (306). These messages can trigger performance of different computations of rates and limits, for example, as discussed in relation to processes 200, 220, 240, and 250 of FIGS. 2A-2D.

For example, after a message with a notification that an application has been started on a device (301), an initial configuration determined for the device, a determination of limits for utilization of memory can be made. For example, initial configuration data relevant for configuring storage utilization for the application on the device can be determined. The initial configuration data includes a first limit for utilization of a memory of the device or a second limit for utilization of a disk of the device.

The utilization limits can be determined based on current user profile and user behavior in interactions with content. The utilization limits based on the user profile can take into consideration current utilization levels of the device for the given user (or for a group of the user to which the user can be associated).

When an application is started, the initial configuration that is set for the device can include a disk deletion ratio 307 and a memory deletion ratio 308, that can correspond substantially to the described first and second limit for storage utilization at the device as in 222 of FIG. 2B. Table 1 below shows an example definition of memory and disk initial limits that can be part of the initial configuration and defined based on a user profile indicative of the user's disk utilization.

TABLE 1

| user tags | Initial Memory Limit | Initial Disk Limit |
|---|---|---|
| Disk utilization = (0, 0.2] | 20MB | 50MB |
| Disk utilization = (0.2, 0.4] | 40MB | 80MB |
| Disk utilization = (0.4, 0.6] | 100MB | 120MB |
| Disk utilization = (0.6, 0.8] | 160MB | 170MB |
| Disk utilization = (0.8, 1] | 200MB | 300MB |

As described in relation to FIG. 2D, the initial configuration for a device can be adjusted based on user behavior. Different increments can be defined to modify the initial memory and disk limits so that the limits are adjusted based on modifications in the initial utilization.

In some cases, a modification to the initial configuration may be performed with consideration of the type of the device that the user is using. As such, the initial limits from the configuration can be adjusted based on understanding of what is the type of the device. In some instances, based on obtained data for the device, the device can be classified, for example, as a low-end, mid-end, or a high-end device. Such categorization can be done to identify the amount of disk resources and memory resources for the device with regard to a predefined scale for the classification. For example, low-end devices can be considered to be devices with less than 512 GB of hard disk, and less than 2 GB RAM. Table 2 below shows an example definition of memory and disk increment modifications for the first and second limits to adjust the initial configuration based on a device level as categorized.

TABLE 2

| Device level | Memory increment | Disk increment |
|---|---|---|
| Low-end | 10MB | 20MB |
| Mid-end | 20MB | 40MB |
| High-end | 30MB | 60MB |

When a write operation is received as indicated at 302, as described in relation to FIG. 2C, the write operation can be for a new video file, and a memory optimization decision 309 can be computed by determining a type of the disk write operation. If the type of the disk write operation is a playback operation, determining whether to store the new video on the disk of the device can be based on determining whether a used portion of the memory including a portion for storing the new video would exceed the first limit for utilization of the memory. In that case, a check for the memory utilization can be made together with obtaining data for the new video file, and that input can be used to determine whether or not to store the video on the disk.

A file deletion decision 316 can be made based on a poll request 303 to determine a status of files. For example, as described in relation to FIG. 2A, weighted ratios for each of the videos can be determined based on computing a ratio between a lifespan of a video and a duration of time for storing the video. A determination can be made to delete a video, as stored in memory or on the disk, according to an ordering the videos based on the weighted ratio and applying a deletion ratio defined for the device, for example, as part of the initial configuration, and/or as adjusted based on considerations for the device level and/or behavior of the user when scrolling through content.

In some examples, based on the user behavior profile a deletion ratio can be determined for the memory or the disk as shown in Table 3 below.

TABLE 3

| User portrait | Disk deletion ration |
|---|---|
| Almost no upward sliding | 0.8 |
| Number of upward slides/100vv = (1, 2] | 0.7 |
| Number of upward slides/100vv = (2, 3] | 0.6 |
| Number of upward slides/100vv > 3 | 0.5 |

In some instances, in response to determining a limit for utilization of the memory (e.g., memory deletion ratio 308), a deletion ratio for removing videos from the memory (e.g., based on considerations for user's behavior such as upwards sliding), and a list of videos stored in the memory, one or more videos from the list of videos can be determined to be deleted from the memory. The determination can be made by applying the deletion ratio to maintain utilization of the memory below the first limit. For example, a user may perform upward sliding interaction with the device (e.g., by performing a gesture, interaction with the display, or other) may be performed when a user requests to replay a previously viewed video part of a feed of the user, e.g., replay a particular video.

In some instances, in response to obtaining data for user interaction of a user of the device (304) with a plurality of videos streamed from a server to the application, a memory deletion ratio for removing stored videos from a memory of the device can be determined. Based on data for a set of videos cached in the memory of the device, or segments that have been played (as in 305), a video from the set of videos from the memory by using the memory deletion ratio can be determined to be deleted.

A repeat probability calculator 311 can be triggered to compute repeat probability for videos based on user interaction data 304 and information 305 for a segment (or whole video) that is being played. In some cases, videos can each be of a long video type and data for segments of the videos can be considered, as segments are smaller portions of the long videos (e.g., above a threshold number of seconds, such as above 60 seconds). In some instances, videos that are above a threshold number of seconds can be managed through video segmentation and considering data for each segment.

The repeat probability as computed by the repeat probability calculator 311 can be based on considerations including one or more of:
1. Mapping of a basic repeat probability to each video based on a video tag. For example, the basic repeat probability can be defined based on a video type classification as shown on Table 4 below.

TABLE 4

| Video type | Basic replay probability P_{b} |
|---|---|
| Almost never played repeatedly | 0.1 |
| Number of repetitions/100vv = (1, 3] | 0.3 |
| Number of repetitions/100vv = (3, 5] | 0.6 |
| Number of repetitions/100vv > 5 | 0.9 |

2. Adjusting the repeat probability based on a page tag where the video is provided at the application's interface. For example, videos on other pages viewed from the user interface of the application may have lower repeat probabilities, while videos on a personal page of the user may have higher repeat probabilities. The probability can be defined as an index on a scale, e.g., an amplification factor, where different factors can account for a different index increment, where multiple increments can be accumulated into a total repeat probability score.
   For example, different amplification factors can be considered when adjusting the repeat probability based on page tags as shown on Table 5 below.

TABLE 5

| Page tag | Amplification factor α |
|---|---|
| Feed Page | 1 |
| Others page | 0.8 |
| Personal page | 1.2 |

3. The closer the user's current position is to a most recently watched video within a file of multiple videos streamed to the user device, the higher the probability of replay.
4. The longer the historical viewing interval, the lower the repeat probability.

The repeat probability of a video can be denoted as P(t), in relation to a viewing position of the video in a list of videos (L) streamed to the device and a current playing video file's being considered as the viewing position (C′). A base repeat probability P_{b} and a page-specific amplification factor α can be represented as a function of the historical time t while the video was stored. The repeat probability can be presented as shown in the example formula below:

$$P ( t ) = {P}_{b} {e}^{- \vert L - C \vert} + α / t$$

A lifespan calculator 312 can be triggered based on calculating a repeat probability for a video. For example, the lifespan calculator 312 can perform operations as described in relation to FIG. 2A, at operation 202. The lifespan for a given video can be relevant for maintaining the video as stored on the disk of the device or in the memory of the device. The lifespan can be determined based on adjusting the computed repeat probability rate (as provided by the repeat probability calculator 311) based on identified interaction of the user to scroll in a direction relative to the new video within streamed videos from the server to the application.

The lifespan for a video can be determined based on a type of the video to be a short video or a long video. In some cases, determining the lifespan of the video is determined when the user has scrolled away from the video being a short video or when the user has scrolled away from a segment of the video being a long video.

In some instances, the lifespan of a video can be determined with considerations for the user behavior to scroll away from a given video file. If the direction of the scroll is away from the file position, the lifespan can be reduced by applying a decreasing exponential factor to the replay probability, for example, to reduce the lifespan incrementally. If the direction of the scroll is towards the file position in a list of videos, the repeat probability can be increased and the lifespan can be amplified. In some cases, the playback duration of a previous video(s) may also be considered to extend the lifespan of the video. By applying such adjustments, the higher the repeat probability of a file, the longer the memory lifespan of that file would be determined. As such, by each replay of a video, the memory lifespan for a subsequent video can double.

Once a download task is completed (306), a disk optimization decision 313 can be triggered to evaluate the videos being stored and to apply logic to determine whether to delete a given video or not for the memory or from the disk of the device. For example, such disk optimization decision 313 can be made based on executing processes 200, 220, 240, and 250 of FIGS. 2A-2D, and as described at various components of the strategy 324 layer of the device storage optimizer 310.

Based on decisions including determination whether or not to delete a video file stored on the disk or in the memory of the device, instructions can be sent to the executor 325 so that memory optimizer 314 or the disk optimizer 315 are triggered to execute the relevant deletions.

By predicting the repeat probability of videos on a user device and managing videos' lifespans, it is possible to reduce the frequency of disk I/O and storage duration at the user device. By implementing techniques of the present disclosure, a balance between disk utilization and download costs can be achieved.

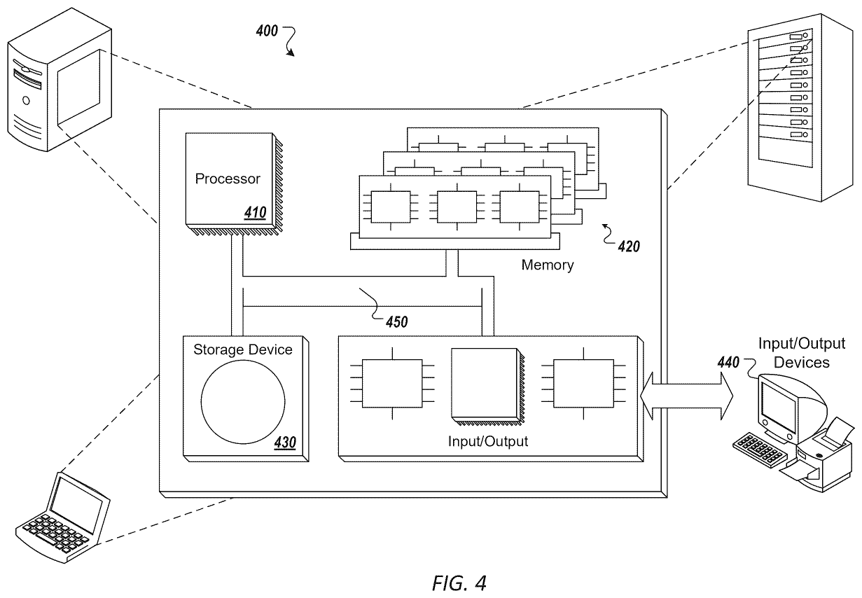

FIG. 4 is a block diagram of a schematic diagram of an example computing system 400. The system 400 can be used for the operations described in association with the implementations described herein. For example, the system 400 may be included in any or all of the components of the content delivery system or video processing systems discussed in this specification. The system 400 includes a processor 410, a memory 420, a storage device 430, and an input/output device 440. The components 410, 420, 430, and 440 are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

In this specification, the term “database” will be used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” will be used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative:

Embodiment 1 is a method, the method comprising:
determining lifespans of videos stored on a disk of a device or in a memory of the device, wherein the lifespan is determined based on computed repeat probability rates for the videos;
computing weighted ratios for each of the videos, wherein a weighted ratio for a video is computed as a ratio between a lifespan of the respective video and a duration of time for storage of the video on a) the disk or b) in memory; and
determining to remove one or more video from the videos based on applying a deletion ratio over a sorted list of the videos, wherein the sorted list is generated based on the computed weighted ratios, and wherein the deletion ratio is defined for the device based on a user device profile.

Embodiment 2 is the method of Embodiment 1, comprising:
executing deletion of the determined one or more videos to be removed, respectively, from the memory or from the disk of the device.

Embodiment 3 is the method of any one of the previous Embodiments, comprising:
obtaining, at an application started on the device, initial configuration data relevant for configuring storage utilization for the application on the device, wherein the initial configuration data comprises a first limit for utilization of a memory of the device or a second limit for utilization of a disk of the device.

Embodiment 4 is the method of Embodiment 3, comprising:
in response to obtaining data for user interaction of a user of the device with a plurality of videos streamed from a server to the application, determining a memory deletion ratio for removing stored videos from a memory of the device; and
in response to obtaining data for a set of videos cached in the memory of the device, determining to delete a video from the set of videos from the memory by using the memory deletion ratio.

Embodiment 5 is the method of Embodiment 3, comprising:
in response to obtaining user interaction of a user of the device with a plurality of videos streamed from a server to an application started on the device, determining a deletion ratio for removing stored videos from memory or from disk of the device;
in response to receiving a disk write operation for a new video to be streamed by the server to the application on the device,
   storing the new video in the memory of the device, and
   computing a repeat probability rate for the new video based on probability measurement rules;
determining a lifespan for the new video for maintaining the new video as stored on the disk of the device or in the memory of the device based on adjusting the computed repeat probability rate based on identified interaction of the user to scroll in a direction relative to the new video within streamed videos from the server to the application; and
in response to determining the lifespan of the new video and the deletion ratio for removing stored videos from the memory or from the disk of the device, determining whether to remove the new video from the memory or from the disk.

Embodiment 6 is the method of Embodiment 5, comprising:
in response to determining the first limit for utilization of the memory, the deletion ratio for removing videos from the memory, and a list of videos stored in the memory, determining one or more videos from the list of videos to be deleted from the memory by applying the deletion ratio to maintain utilization of the memory below the first limit.

Embodiment 7 is the method of Embodiment 5, wherein determining the one or more videos from the list of videos to be deleted from the memory comprises, writing the one or more videos to the disk of the device.

Embodiment 8 is the method of Embodiment 6, comprising receiving the disk write operation comprising:
determining a type of the disk write operation; and
in response to determining that the type of the disk write operation is a playback operation,
   determining whether to store the new video on the disk of the device based on determining whether a used portion of the memory including a portion for storing the new video would exceed the first limit for utilization of the memory.

Embodiment 9 is the method of Embodiment 4, wherein the initial configuration data is obtained from a server communicatively coupled to the application to provide video streaming, wherein the initial configuration is defined based on a user profile associated with the application running on the device and a device profile of the device.

Embodiment 10 is the method of Embodiment 4, comprising:
dynamically adjusting the initial configuration data relevant for configuring disk utilization for the application on the device based on identifying user behavior scrolling through videos streamed from the server at the application, wherein adjusting the initial configuration comprises:
   determining a user profile of the user of the device and a device profile of the device; and
   using the user profile and the device profile to determine a first incremental space adjustment for the first limit for utilization of the memory of the device and a second incremental space adjustment for the second limit for utilization of the disk of the device.

Embodiment 11 is the method of Embodiment 5, wherein determining the lifespan for the new video for maintaining as stored on the disk of the device or in the memory of the device comprises determining a type of the video to be a short video or a long video, and wherein determining the lifespan of the new video is determined when the user has scrolled away from the video being a short video or when the user has scrolled away from a segment of the video being a long video.

Embodiment 12 is a system comprising: one or more computers and one or more storage devices storing instructions that are operable, when executed by the one or more computers, to cause the one or more computers to perform the method of any one of embodiments 1 to 11.

Embodiment 13 is a computer storage medium encoded with a computer program, the program comprising instructions that are operable, when executed by data processing apparatus, to cause the data processing apparatus to perform the method of any one of embodiments 1 to 11.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
determining lifespans of videos stored on a disk of a device or in a memory of the device, wherein the lifespan is determined based on computed repeat probability rates for the videos;
computing weighted ratios for each of the videos, wherein a weighted ratio for a video is computed as a ratio between a lifespan of the respective video and a duration of time for storage of the video on a) the disk or b) in memory; and
determining to remove one or more video from the videos based on applying a deletion ratio over a sorted list of the videos, wherein the sorted list is generated based on the computed weighted ratios, and wherein the deletion ratio is defined for the device based on a user device profile.

2. The method of claim 1, comprising:
executing deletion of the determined one or more videos to be removed, respectively, from the memory or from the disk of the device.

3. The method of claim 1, comprising:
obtaining, at an application started on the device, initial configuration data relevant for configuring storage utilization for the application on the device, wherein the initial configuration data comprises a first limit for utilization of a memory of the device or a second limit for utilization of a disk of the device.

4. The method of claim 3, comprising:
in response to obtaining data for user interaction of a user of the device with a plurality of videos streamed from a server to the application, determining a memory deletion ratio for removing stored videos from a memory of the device; and
in response to obtaining data for a set of videos cached in the memory of the device, determining to delete a video from the set of videos from the memory by using the memory deletion ratio.

5. The method of claim 3, comprising:
in response to obtaining user interaction of a user of the device with a plurality of videos streamed from a server to an application started on the device, determining a deletion ratio for removing stored videos from memory or from disk of the device;
in response to receiving a disk write operation for a new video to be streamed by the server to the application on the device,
storing the new video in the memory of the device, and
computing a repeat probability rate for the new video based on probability measurement rules;
determining a lifespan for the new video for maintaining the new video as stored on the disk of the device or in the memory of the device based on adjusting the computed repeat probability rate based on identified interaction of the user to scroll in a direction relative to the new video within streamed videos from the server to the application; and
in response to determining the lifespan of the new video and the deletion ratio for removing stored videos from the memory or from the disk of the device, determining whether to remove the new video from the memory or from the disk.

6. The method of claim 5, comprising:
in response to determining the first limit for utilization of the memory, the deletion ratio for removing videos from the memory, and a list of videos stored in the memory, determining one or more videos from the list of videos to be deleted from the memory by applying the deletion ratio to maintain utilization of the memory below the first limit.

7. The method of claim 5, wherein determining the one or more videos from the list of videos to be deleted from the memory comprises, writing the one or more videos to the disk of the device.

8. The method of claim 6, comprising receiving the disk write operation comprising:
determining a type of the disk write operation; and
in response to determining that the type of the disk write operation is a playback operation,
determining whether to store the new video on the disk of the device based on determining whether a used portion of the memory including a portion for storing the new video would exceed the first limit for utilization of the memory.

9. The method of claim 4, wherein the initial configuration data is obtained from a server communicatively coupled to the application to provide video streaming, wherein the initial configuration is defined based on a user profile associated with the application running on the device and a device profile of the device.

10. The method of claim 4, comprising:
dynamically adjusting the initial configuration data relevant for configuring disk utilization for the application on the device based on identifying user behavior scrolling through videos streamed from the server at the application, wherein adjusting the initial configuration comprises:
determining a user profile of the user of the device and a device profile of the device; and
using the user profile and the device profile to determine a first incremental space adjustment for the first limit for utilization of the memory of the device and a second incremental space adjustment for the second limit for utilization of the disk of the device.

11. The method of claim 5, wherein determining the lifespan for the new video for maintaining as stored on the disk of the device or in the memory of the device comprises determining a type of the video to be a short video or a long video, and wherein determining the lifespan of the new video is determined when the user has scrolled away from the video being a short video or when the user has scrolled away from a segment of the video being a long video.

12. A system comprising:
one or more computers and one or more storage devices on which are stored instructions that are operable, when executed by the one or more computers, to cause the one or more computers to perform operations comprising:
determining lifespans of videos stored on a disk of a device or in a memory of the device, wherein the lifespan is determined based on computed repeat probability rates for the videos;
computing weighted ratios for each of the videos, wherein a weighted ratio for a video is computed as a ratio between a lifespan of the respective video and a duration of time for storage of the video on a) the disk or b) in memory; and
determining to remove one or more video from the videos based on applying a deletion ratio over a sorted list of the videos, wherein the sorted list is generated based on the computed weighted ratios, and wherein the deletion ratio is defined for the device based on a user device profile.

13. The system of claim 12, wherein the one or more storage devices store further instructions which, when executed by the one or more computers, cause the one or more computers to perform operations comprising:
executing deletion of the determined one or more videos to be removed, respectively, from the memory or from the disk of the device.

14. The system of claim 12, wherein the one or more storage devices store further instructions which, when executed by the one or more computers, cause the one or more computers to perform operations comprising:
obtaining, at an application started on the device, initial configuration data relevant for configuring storage utilization for the application on the device, wherein the initial configuration data comprises a first limit for utilization of a memory of the device or a second limit for utilization of a disk of the device.

15. The system of claim 14, wherein the one or more storage devices store further instructions which, when executed by the one or more computers, cause the one or more computers to perform operations comprising:
in response to obtaining data for user interaction of a user of the device with a plurality of videos streamed from a server to the application, determining a memory deletion ratio for removing stored videos from a memory of the device; and
in response to obtaining data for a set of videos cached in the memory of the device, determining to delete a video from the set of videos from the memory by using the memory deletion ratio.

16. The system of claim 14, wherein the one or more storage devices store further instructions which, when executed by the one or more computers, cause the one or more computers to perform operations comprising:
in response to obtaining user interaction of a user of the device with a plurality of videos streamed from a server to an application started on the device, determining a deletion ratio for removing stored videos from memory or from disk of the device;
in response to receiving a disk write operation for a new video to be streamed by the server to the application on the device,
storing the new video in the memory of the device, and
computing a repeat probability rate for the new video based on probability measurement rules;
determining a lifespan for the new video for maintaining the new video as stored on the disk of the device or in the memory of the device based on adjusting the computed repeat probability rate based on identified interaction of the user to scroll in a direction relative to the new video within streamed videos from the server to the application; and
in response to determining the lifespan of the new video and the deletion ratio for removing stored videos from the memory or from the disk of the device, determining whether to remove the new video from the memory or from the disk.

17. The system of claim 16, wherein the one or more storage devices store further instructions which, when executed by the one or more computers, cause the one or more computers to perform operations comprising:
in response to determining the first limit for utilization of the memory, the deletion ratio for removing videos from the memory, and a list of videos stored in the memory, determining one or more videos from the list of videos to be deleted from the memory by applying the deletion ratio to maintain utilization of the memory below the first limit.

18. One or more non-transitory computer-readable storage media encoded with instructions that, when executed by one or more computers, cause the one or more computers to perform operations comprising:
determining lifespans of videos stored on a disk of a device or in a memory of the device, wherein the lifespan is determined based on computed repeat probability rates for the videos;
computing weighted ratios for each of the videos, wherein a weighted ratio for a video is computed as a ratio between a lifespan of the respective video and a duration of time for storage of the video on a) the disk or b) in memory; and
determining to remove one or more video from the videos based on applying a deletion ratio over a sorted list of the videos, wherein the sorted list is generated based on the computed weighted ratios, and wherein the deletion ratio is defined for the device based on a user device profile.

19. The non-transitory computer-readable storage media of claim 18, comprising instructions which when executed by the one or more computers, cause the one or more computer to perform operations comprising:
executing deletion of the determined one or more videos to be removed, respectively, from the memory or from the disk of the device.

20. The non-transitory computer-readable media of claim 18, comprising instructions which when executed by the one or more computers, cause the one or more computer to perform operations comprising:
obtaining, at an application started on the device, initial configuration data relevant for configuring storage utilization for the application on the device, wherein the initial configuration data comprises a first limit for utilization of a memory of the device or a second limit for utilization of a disk of the device.
